(19) United States
(12) Patent Application Publication
(10) Pub. No.: US 2020/0277731 A1
(43) Pub. Date: Sep. 3, 2020

(54) METHOD FOR THE PRODUCTION OF SYNTHETIC LEATHER

(71) Applicant: Merck Patent GmbH, Darmstadt (DE)

(72) Inventor: Edric CHEN, Shanghai (CN)

(73) Assignee: Merck Patent GmbH, Darmstadt (DE)

(21) Appl. No.: 16/764,111

(22) PCT Filed: Nov. 12, 2018
(86) PCT No.: PCT/EP2018/080921

§ 371 Date: May 14, 2020

(30) Foreign Application Priority Data
Nov. 15, 2017 (CN) 201711127520.9

(51) Int. Cl. D06N 3/14; D06N 3/00; B44C 1/17; B44F 7/00

(52) U.S. Cl. CPC D06N 3/14; D06N 3/0097; D06N 2211/28; B44F 7/00; B44C 1/1733

(57) ABSTRACT

The present invention relates to a method for the production of synthetic leather, to synthetic leather produced by such a method as well as to the use thereof. In particular, the present invention relates to a method for the production of synthetic leather exhibiting a virtual three-dimensional pattern on its visible face, whereby the leather comprises platelet-shaped effect pigments.

The present invention relates to a method for the production of synthetic leather, to synthetic leather produced by such a method as well as to the use thereof. In particular, the present invention relates to a method for the production of synthetic leather exhibiting a virtual three-dimensional pattern on its visible face, whereby the leather comprises platelet-shaped effect pigments.

Synthetic leathers are widely used in daily life, for instance for the production of interior automotive parts, clothes, shoes, bags, belts, playing balls, furniture or upholstery, to name only a few. Big efforts have been made in the last decades to improve the application characteristics as well as the optical appearance of synthetic leathers. In particular for the application in clothes or shoes, the synthetic leather must be flexible, wear resistant and breathing and shall often resemble natural leather in its optical characteristics.

On the other side, synthetic leathers bring about the opportunity to provide the material with optical characteristics which are far away from the optical behaviour of natural leathers, leading to decorative materials which are outstanding in their optical characteristics and might be used in order to achieve attraction, to set fashion trends and to create optical highlights. To this end, in some applications, platelet-shaped effect pigments which may impart intensely coloured, optically variable or metallic optical characteristics to synthetic leathers have already been used in the production of synthetic leathers from time to time.

Nevertheless, the customers are still eager to get attractive objects having impressive but unusual optical characteristics for their daily life use.

Therefore, it would be of advantage to find a technical solution for the optical amendment of synthetic leathers in order to create outstanding optical effects on the leather surface while fitting perfectly to the usually used production methods for synthetic leathers and being applicable with comparatively low technical effort and machinery.

The mostly used method for the production of synthetic leathers is the so called reverse coating method using polyurethane compounds, where a release layer, called release paper, is provided with two or three layers of polyurethane compounds on top of each other, where the layer coated in the ultimate step is laminated, when still wet, with a substrate layer which is often of a woven or non-woven fabric. After hardening all layers, the release layer, which is often provided with heights and depressions and may, therefore, be used to provide a three-dimensional pattern similar to natural leather grains to the top coat of the synthetic leather, is removed from the then achieved layer stack. The resulting visible top coat of the synthetic leather often contains dyes or colour pigments for creating the colour of the surface whereas the three-dimensional pattern provided by the release paper brings about the natural or fashionable look.

As far as the top coat of the synthetic leather contains soluble dyes or usual organic or inorganic colour pigments, the use of the release paper to create the requested three-dimensional pattern in the top coat layer creates no problems, since soluble dyes mix homogeneously with the binder composition of the top coat and usually used organic or inorganic colour pigments exhibit such small particle sizes, that the coating composition containing them fills perfectly the depressions in the release paper in order to achieve a distinctly structured three-dimensional surface of the top coat after the release paper is removed therefrom. To the contrary, the same procedure would not impart a three-dimensional pattern to the top coat of a synthetic leather if the top coat would be coloured with platelet-shaped effect pigments, since these pigments exhibit usually comparatively large particle sizes and due to their platelet shape and size, they will not fill perfectly the depressions of the release paper so that a distinct three-dimensional pattern on the upper surface of the top coat would not be achievable by such a process. If at all, the achievable structure of the top coat of a synthetic leather would be that of a visible two-dimensional or very weak three-dimensional pattern having neither attraction nor desired quality.

Therefore, the object of the present invention is to provide a process for the production of synthetic leather which results in an attractive visible face of the synthetic leather giving the impression of a three-dimensional pattern by using platelet-shaped effect pigments.

In addition, the object of the present invention is to provide synthetic leather which exhibits on its visible face a distinct three-dimensionally appearing pattern exhibiting gloss, attractive intense or optically variable colours or metallic appearance.

Furthermore, another object of the present invention is to provide the possible use of the synthetic leather produced in this way.

Surprisingly, the present inventors have found that the usually used reverse coating process for the production of synthetic leather may be used for the creation of three-dimensional appearing effects on the visible face thereof, if a certain protective layer is applied to the synthetic leather on the visible top layer of the synthetic leather after removal of the release paper.

The present invention thus relates to a method for the production of synthetic leather having a back face and a visible face and exhibiting a virtual three-dimensional pattern on the visible face, wherein
a) a release sheet having an upper surface carrying a three-dimensional pattern thereon is coated with
b) a first layer containing platelet-shaped effect pigments and a polyurethane compound directly onto the upper surface of the release sheet, and the first layer is thereafter coated with
c) at least one further layer comprising a polyurethane compound, and
d) the further layer in a wet state is brought into contact with a substrate layer and laminated thereto, and
e) the first and the at least one further polyurethane containing layers applied to the release sheet are solidified either singly after steps b) and d) or in combination with each other after step d), whereby a layered stack of solid layers of at least the further layer, the first layer and of the release sheet on the substrate layer is achieved, and thereafter
f) the release sheet is removed from the layered stack, thereby revealing a surface of the first layer containing platelet-shaped effect pigments which exhibits a virtual two-dimensional pattern which is then coated with a coating composition comprising a moisture curing polyurethane compound and solidified in air for a time period of at least 10 hours to achieve a solid moisture cured polyurethane coating layer.

Furthermore, the present invention relates to synthetic leather having a back face and a visible face and exhibiting a virtual three-dimensional pattern on the visible face, wherein the synthetic leather is composed of a substrate layer having thereon a stack of polyurethane containing layers, where the polyurethane containing layer which is the furthermost layer from the substrate layer comprises platelet-shaped effect pigments and is covered on its upper surface by a moisture cured polyurethane layer.

In addition, the present invention relates to the use of synthetic leather produced in the above mentioned way for the production of clothes, shoes, bags, belts, playing balls, automotive parts, furniture and upholstery.

The present invention is based on a reversed coating process for the production of synthetic leathers which is known per se. In such a process, synthetic leather is produced by coating a release paper which may exhibit an upper surface carrying a three-dimensional pattern thereon with a first layer containing a polyurethane compound and, optionally, a dye or a transparent inorganic or organic colouring pigment directly onto the upper surface of the release paper, and the first layer is thereafter coated with a second layer comprising a polyurethane compound, to which a substrate layer is laminated as long as the second layer is still in an uncured state. Optionally, between the first and the second layer, a middle layer may be present which usually comprises a polyurethane compound as well and might be present in the form of a polyurethane foam.

After the second layer being laminated to the substrate layer is hardened and solidified as the first layer is too, the release paper is removed from the surface of the thus produced layered stack, resulting in an artificial leather which might exhibit a three-dimensional pattern on its upper surface, depending on whether or not the release paper carried such a three-dimensional pattern on its upper surface.

As described earlier already, such a process would not lead to the production of a synthetic leather having a three-dimensional pattern on its upper surface in case that, instead of a dye or of a transparent inorganic or organic colouring pigment, platelet-shaped effect pigments would have been used for the coloration of the top layer of the leather which is the first layer in the process described above.

Since platelet-shaped effect pigments may provide lustrous as well as intense and/or optically variable (interference) colours or metallic appearance to any object which they are applied to, it was highly desired to find a way to bring the optical advantages of platelet-shaped effect pigments in coincidence with attractive three-dimensional patterns on the surfaces of synthetic leathers. Therefore, the present inventors did eagerly try to find a way how these desirable effects could be readily combined in synthetic leathers.

Surprisingly, it was found that the provision of an additional, certain polyurethane containing coating on top of the upper surface of the synthetic leather, as soon as a release sheet having a three-dimensional pattern thereon is removed from the first layer which contains platelet-shaped effect pigments instead of dyes or inorganic or organic colouring pigments, may solve this technical problem. This certain polyurethane containing coating must fulfil some pre-requisites, otherwise, the desired effect would not be observable.

The first pre-requisite is that the certain polyurethane containing coating must be a moisture curing polyurethane containing coating leading to a continuous moisture cured polyurethane coating layer on top of the layer containing the platelet-shaped effect pigments. The resulting moisture cured polyurethane coating layer shall advantageously exhibit a thickness in the range of from 250 μm to 1000 μm, in particular of from 400 to 600 μm.

Moisture curing polyurethanes which may also be named polyurethane pre-polymers are very well known in the art. They represent isocyanate-terminated polyurethane pre-polymers that are formulated to cure with ambient water. The ambient water is usually taken from the atmosphere (air) surrounding the polyurethane pre-polymer. The pre-polymers are usually made from polyisocyanates and compounds having a plurality of hydroxyl groups of different compositions. When reacting a polyol with an excess of polyisocyanate, the pre-polymer having a free isocyanate group content is produced, which may be applied to surfaces either as it is or in a dissolved liquid state. After application to a substrate, the coated layer may be cured through reaction with moisture in the atmosphere.

Besides the unreacted (free) isocyanate (NCO—) groups in the molecule, the pre-polymer containing coating composition according to the present invention may also contain a certain amount of a component having free hydroxyl groups (OH—) in the molecule in order to facilitate the curing. This might be of importance, since the ratio of unreacted NCO— groups to unreacted OH— groups influences the mechanical characteristics of the resulting polyurethane. By adding a compound containing free OH— groups, for instance a polyol, the said ratio may be lowered to a certain extent which might be advantageous with respect to the flexibility of the resulting polyurethane layer which diminishes at a high NCO/OH ratio.

The second pre-requisite for the moisture curing polyurethane to be used in the process according to the present invention is a curing time of at least 10 hours. Depending on the ambient conditions of the respective curing process, the curing time may be prolonged to 24 hours, 36 hours or 48 hours, as the case may be. Of course, a too long curing time would lengthen the production process of the synthetic leather to an extent which might be unfavourable. Therefore, the curing time shall advantageously be in the range of from 10 to 48 hours, in particular from 20 to 30 hours.

This relative long time period for a single curing step enables the resulting moisture cured polyurethane layer to exhibit a soft but nevertheless mechanically stable performance, leads to a smooth touch of the outer surface of the layer, to a plane structure thereof and to a shiny or at best glossy look.

The coating composition containing the moisture curing polyurethane compound may be solidified (cured) at a temperature in the range of from 12° C. to 30° C. and at a relative humidity (RH) of the surrounding air in the range of from 40 to 80%. Regarding said conditions, it is favourable to choose the curing temperature in the lower above mentioned range in case the relative humidity of the air is high and to choose, vice versa, a rather high temperature in the above mentioned range in case the relative humidity of the air is rather low. Otherwise, the curing of the moisture curing polyurethane coating would be either too rapid or too slow, leading to unfavourable mechanical characteristics of the resulting moisture cured polyurethane containing coating.

Moisture curing polyurethanes are available in a huge variety in the market. The respective materials may be chosen by the skilled person according to the intended characteristics of the resulting moisture cured polyurethane containing layer, e.g. the hardness, glossiness, transparency, flexibility, etc., thereof.

The moisture curing polyurethanes containing coating compositions or ready-to-use coating compositions available in the market useful for the present process may also comprise several fillers and usual additives such as curing catalysts, thickeners, coupling agents, extenders or UV stabilizers. These may be applied according to the general knowledge of the skilled person, but are limited to such an extent that the transparency of the resulting moisture cured polyurethane containing coating layer is not adversely effected thereby.

Furthermore, the moisture curing polyurethanes containing coating composition may additionally comprise at least one dye or at least one transparent organic or inorganic colour pigment. Dyes or pigments of said kind lead to an alteration or adaption of the visible colour of the moisture cured polyurethane top layer of the resulting synthetic leather due to the respective desires of the user. Since the moisture cured polyurethane coating top layer of the synthetic leather produced according to the present process is transparent to visible light to such an extent that at least 90% of the visible light is transmitted by this layer, the first layer in the inventive process, containing the platelet shaped effect pigments, is readily visible when the synthetic leather is viewed from its visible face. Thus, usually the optical characteristics of the platelet shaped effect pigments in the first layer determine the colour and colour effects which are visible when the synthetic leather is used. Dyes and transparent organic or inorganic pigments contained in the moisture cured polyurethane coating layer enable an adaption or even alteration of the visible colour effects of the platelet shaped effect pigments in the synthetic leather. For instance, a golden interference colour of platelet shaped effect pigments in the first layer may be altered to a slight orange hue in case that an orange dye is included in the moisture curing polyurethane compound containing coating composition. Even if optically variable pigments are used as platelet shaped effect pigments, their defined viewing angle dependent colour flop may be changed completely, for instance when a first layer having a red to gold colour flopping effect pigment included is overcoated by a moisture curing polyurethanes containing coating layer having a transparent blue pigment or a blue dye contained therein. In such a case, the original red/gold colour flop of the platelet shaped effect pigment may be altered to a lilac/green colour flop being visible at the visible face of the synthetic leather. Interesting variable colour effects may be achieved by adding such dyes or transparent organic or inorganic pigments while using only one single kind of platelet shaped effect pigments in the first layer, let alone if different kinds of platelet shaped effect pigments are used in the first layer.

With respect to the dyes and organic or inorganic transparent pigments which may be used in the moisture curing polyurethanes containing coating composition, the kind thereof is not restricted. All dyes and transparent pigments which are not platelet shaped and are usually used for colouring paints, prints, plastics etc. may be used, provided that they are soluble in the coating composition or transparent in nature due to their tiny particle size, since the moisture curing polyurethanes containing coating composition, when cured, must result in a transparent (see above) moisture cured coating layer, where the pigments of the underlying first layer must be readily visible.

When the release sheet carrying a three dimensional pattern on its upper surface (which, in the solid layered stack, constitutes the surface of the release sheet which is localized between the substrate and the visible and touchable surface of the release sheet prior to its removal from the layered stack on the substrate) is removed from the layered stack on the substrate, the upper surface of the first layer is revealed. This surface carries very weak depressions which correspond in shape (but not in depth) to the heights on the upper surface of the release sheet which was coated before with the first platelet shaped pigments and polyurethane containing first layer. Since, as already described above, the heights in the release sheet are not powerful and sharp enough to create distinct and sharp lined depressions in the first layer due to the platelet shape of the effect pigments included (which are spatially hindered due to their size and shape to fill the depressions in the release sheet while not covering the heights on the release sheet), the depressions which may be observed in the first layer after removal of the release sheet are very weak, if at all observable. Therefore, the pattern which may be observed at the outer surface of the first layer after removal of the release sheet may be regarded virtually two-dimensional, although there might be some tiny recesses in this layer. The virtual two-dimensional shape of the pattern corresponds to the basic outer shape of the three-dimensional pattern on the upper surface of the release sheet which is created by the heights on the upper surface of the release sheet. This virtual two-dimensional pattern on the upper surface of the first layer in fact consists of area elements and line elements, whereby the line elements are regularly or irregularly distributed between the area elements and wherein the size of the area elements is from 0.5 mm² to 10 cm². If the size of the area elements would be smaller than 0.5 mm², the visible virtual three-dimensional pattern on the visible face of the resulting synthetic leather would not be distinct enough in order to be readily visible, so that the three-dimensional effect would be diminished. In addition, if the area elements would be much larger than 10 cm², the area elements would be so large that a three-dimensional effect would be merely slightly visible, since the optical impression of 3D occurs at the boundary lines of area elements and line elements of the pattern.

The moisture cured polyurethane containing coating layer, which is applied onto this upper surface of the synthetic leather according to the present invention serves surprisingly as a means which is capable to intensify and magnify the very weak three-dimensional pattern (which is virtually two-dimensional without the further coating) on the outer surface of the effect pigment containing layer to such an extent that a clearly visible virtual three-dimensional pattern may be observed on the visible face of the resulting synthetic leather. Insofar, the moisture cured polyurethane containing coating layer on top of the platelet shaped effect pigment containing layer acts similar to a lens or magnifying glass. At the same time, the moisture cured polyurethane containing coating layer does also protect the platelet shaped effect pigment containing layer mechanically and against chemical influences.

For the release sheet, all usually useful release papers which exhibit a three-dimensional pattern on their upper surface to be coated, the three-dimensional pattern consisting of area elements and line elements where the line elements are regularly or irregularly distributed between the area elements, may be used, provided that they are useful for the production of synthetic leathers in general.

The platelet shaped effect pigments containing layer in the present process is applied as a continuous layer to the release sheet. The application may be executed by any coating method known in the art. It goes without saying that coating methods are preferably used which are usually applied for the production of synthetic leathers in a reverse coating process, since the present process shall fit into the usual production procedure and shall contain only the ultimate additional coating step where the moisture curing polyurethane containing layer is applied to the synthetic leather.

The dry thickness of the platelet shaped effect pigments containing layer shall be equal or higher than the largest height of the heights provided on the release layer. Advantageously, the dry thickness of the platelet shaped effect pigments containing layer is in the range of from 10 to 500 μm, in particular of from 50 to 300 μm. Preferably, the platelet shaped effect pigments containing layer, when dry, totally covers the depressions and heights which are present on the upper surface of the release sheet and forms a smooth, continuous layer having uniform thickness.

Platelet shaped effect pigments which are contained in the first layer of the process according to the present invention are taken to mean platelet-shaped pearlescent pigments, platelet-shaped interference pigments which are either predominantly transparent or semi-transparent, and platelet-shaped metal effect pigments.

These platelet-shaped pigments are built up from one or more layers of materials, which may be different if desired.

Pearlescent pigments consist of transparent flakes of high refractive index and exhibit a characteristic pearlescence on parallel alignment due to multiple reflection. Pearlescent pigments of this type which additionally also exhibit interference colours are known as interference pigments.

Although classical pearlescent pigments, such as TiO₂ flakes, basic lead carbonate, BiOCl pigments or nacreous pigments, are of course in principle also suitable, the platelet-shaped effect pigments preferably employed for the purposes of the present invention are interference pigments or metal effect pigments which have at least one coating of a metal, metal oxide, metal oxide hydrate or mixtures thereof, a metal mixed oxide, metal suboxide, metal oxynitride, metal fluoride, BiOCl or of a polymer on an inorganic flake-form support. The metal effect pigments preferably have at least one metal layer. The inorganic flake-form support preferably consists of natural or synthetic mica, kaolin or other phyllosilicates, of glass, SiO₂, TiO₂, Al₂O₃, Fe₂O₃, graphite flakes or of metal flakes, such as, for example, of aluminium, titanium, bronze, silver, copper, gold, steel or various metal alloys.

Particular preference is given to supports of mica, glass, graphite, SiO₂, TiO₂ and Al₂O₃ or mixtures thereof.

The size of these supports is not crucial per se. The supports generally have a thickness of between 0.01 and 5 μm, in particular between 0.05 and 4.5 μm. The extension in the length or width is usually between 1 and 200 μm, preferably between 2 and 200 μm and in particular between 2 and 100 μm, mostly preferred between 10 and 60 μm. They generally have an aspect ratio (ratio of the average diameter to the average particle thickness) of at least 10, in particular of a least 20, and especially of from 20 to 200.

Since the layer thickness of the coating layers on the pigment supports is usually in the nanometer range only, the proportions of the platelet shaped effect pigments which are useful for the present process correspond to those mentioned for the supports above.

For the purposes of the present invention, the particle size is regarded as being the length of the longest axis of the pigments. The particle size can in principle be determined using any method for particle-size determination that is familiar to the person skilled in the art. The particle size determination can be carried out in a simple manner, depending on the size of the laser sensitive pigments, for example by direct observation and measurement of a number of individual particles in high-resolution light microscopes, but better in electron microscopes, such as the scanning electron microscope (SEM) or the high-resolution electron microscope (HRTEM), but also in the atomic force microscope (AFM), the latter in each case with appropriate image analysis software. The determination of the particle size can advantageously also be carried out using measuring instruments (for example Malvern Mastersizer 3000, APA300, Malvern Instruments Ltd., UK), which operate on the principle of laser diffraction. Using these measuring instruments, both the particle size and also the particle-size distribution in the volume can be determined from a pigment suspension in a standard method (SOP). The last-mentioned measurement method is preferred in accordance with the present invention.

A coating applied to the support preferably consists of metals, metal oxides, metal mixed oxides, metal suboxides or metal fluorides and in particular of a colourless or coloured metal oxide selected from TiO₂, titanium suboxides, titanium oxynitrides, Fe₂O₃, Fe₃O₄, SnO₂, Sb₂O₃, SiO₂, Al₂O₃, ZrO₂, B₂O₃, Cr₂O₃, ZnO, CuO, NiO or mixtures thereof.

Coatings of metals preferably comprise aluminium, titanium, chromium, nickel, silver, zinc, molybdenum, tantalum, tungsten, palladium, copper, gold, platinum or alloys thereof.

The metal fluoride employed is preferably MgF₂.

The platelet-shaped effect pigments employed are particularly preferably multilayered effect pigments. These have a plurality of layers, which preferably consist of the above-mentioned materials and have various refractive indices in such a way that in each case at least two layers of different refractive index alternate on the support, on a flake-form, preferably non-metallic support, where the refractive indices in the individual layers differ by at least 0.1 and preferably by at least 0.3. The layers located on the support can be either virtually transparent or coloured or semitransparent.

The platelet-shaped effect pigments described above may be present individually or in a mixture in the first layer which is applied to the release sheet in step b) of the process according to the present invention.

The platelet-shaped effect pigments employed in accordance with the present invention may be transparent or semitransparent, i.e. they may transmit at least 10% of the incident light.

Furthermore, platelet-shaped metal effect pigments which are either composed of a single opaque metal layer or contain at least one opaque metal layer may also be used. For these opaque platelet-shaped pigments, transmittance of the incident light is less than 10%.

Both types of platelet-shaped effect pigments may be used as single pigment types or in combination with each other, whereby combinations of several types of transparent or semi-transparent platelet-shaped pigments with each other are as possible as combinations of several types of opaque metal platelet-shaped pigments or mixtures of transparent or semi-transparent platelet-shaped pigments with opaque metal platelet-shaped pigments. The actual use of pigment types depends on the desired visible colour effects on the surface of the resulting synthetic leather to be produced.

Platelet-shaped effect pigments that can be employed are, for example, the commercially available interference pigments available under the names Iriodin®, Colorstream®, Xirallic® from Merck KGaA, Mearlin® from Mearl, metal-effect pigments from Eckhard and goniochromatic (optically variable) effect pigments, such as, for example, Variochrom® from BASF, Chromafflair® from Flex Products Inc., and other commercially available pigments of the same type. However, this list should merely be regarded as illustrative and not restrictive.

In particular with optically variable platelet shaped effect pigments, which exhibit interference colours changing according to a varying viewing or illumination angle, interesting colour effects may be achieved in the synthetic leather produced.

The platelet shaped effect pigments are contained in the platelet shaped effect pigments containing first layer in an amount of from 5 to 40% by weight, based on the weight of the layer. Advantageously, the content of the platelet shaped effect pigments lies in the range of from 10 to 35% by weight, preferably of from 15 to 25% by weight, based on the weight of the platelet shaped effect pigments containing first layer. Since the coating composition used for the production of this layer does often contain at least one solvent, the content of the platelet shaped effect pigments in the coating composition containing these is, of course, lower than the content thereof in the dried layer if a solvent is present. In general, in such a case the content of the platelet shaped effect pigments in the corresponding coating composition is in the range of from 1 to 30% by weight, based on the weight of the coating composition.

With respect to the polyurethane resin used in the first layer which contains the platelet shaped effect pigments, in principle all polyurethane resins may be used which are available in the market and proved useful for the production of synthetic leathers. Solvent based as well as water based polyurethane coating compositions may be used.

Although polyurethane resin compositions for the production of synthetic leathers usually may contain any fillers or additives, the optical performance of the platelet shaped effect pigments contained in the coating composition for the first layer would be diminished if the content of fillers and other additives in this layer would be too high or if particulate materials would be used which would hamper the optical action of the platelet shaped effect pigments in this layer. Therefore, only small amounts of particulate fillers or additives, if any, are useful for the first coating layer containing the platelet shaped effect pigments.

The at least one further polyurethane containing coating layer is either a single layer containing a common useful polyurethane resin or is a layer stack of two or more polyurethane containing layers. In case that more than one polyurethane containing layer is used as the at least one further polyurethane containing coating layer, it is preferred to use a two-layered stack of a middle layer of a polyurethane foam and another polyurethane containing layer which is laminated in the wet state with the substrate layer for the synthetic leather.

As the substrate layer, woven or non-woven fabric materials, knitted fabrics or combinations thereof are usually used. If applicable, polymer materials may be useful as well.

The present invention is also directed to a synthetic leather having a back face and a visible face and exhibiting a virtual three-dimensional pattern on the visible face, whereby the synthetic leather is composed of a substrate layer having thereon a stack of polyurethane containing layers, where the polyurethane containing layer which is the furthermost layer from the substrate layer comprises platelet-shaped effect pigments and is covered on its upper surface by a moisture-cured polyurethane coating layer.

The synthetic leather according to the present invention is produced by the process as described above. All material details described before with respect to the production process apply to the resulting synthetic leather as well.

Whereas the substrate layer constitutes the back face of the resulting synthetic leather, the outer surface of the moisture cured polyurethane containing coating applied in the ultimate production step constitutes the visible face of the synthetic leather.

As already described before, the moisture cured polyurethane containing coating is transparent, i.e. transmits at least 90% of the incident light. Thus, the visible colour, gloss and, if applicable, colour changing effects of the synthetic leather are determined by the colour, gloss and colour changing effects of the platelet shaped effect pigments contained in the first polyurethane containing layer in case that the moisture cured polyurethane containing coating does neither contain dyes nor transparent organic or inorganic pigments. If present, the visible colour characteristics of the synthetic leather are also influenced by the dyes or transparent organic or inorganic pigments contained in the moisture cured polyurethane containing coating in a manner as described above.

At the visible face of the synthetic leather, a virtual three-dimensional pattern may be observed, which in general exhibits the colour, gloss and colour changing effects of the platelet shaped effect pigments contained in the first layer. These colour effects may be altered and enhanced to a certain extent by dyes and/or organic or inorganic transparent pigments present in the moisture cured polyurethane containing coating. The degree of glossiness may be influenced by the moisture cured polyurethane containing coating as well.

The shape of the visible virtual three-dimensional pattern corresponds in principle to the three-dimensional pattern which is present on the upper surface of the release sheet which was used to produce the synthetic leather. The virtual three-dimensional pattern observable at the visible face of the synthetic leather thus consists of area elements and line elements, whereby the line elements are regularly or irregularly distributed between the area elements and wherein the size of the area elements is from 0.5 mm² to 10 cm².

The basic outer shape of the line elements corresponds to the shape of the heights on the upper surface of the release sheet, whereas the shape of the area elements corresponds to the shape of the depressions on the upper surface of the release sheet. Virtually, the area elements observed on the visible face occur elevated. The optical impression of a three-dimensional pattern occurs at the boundary lines of area elements and line elements distributed within the pattern.

The virtually visible three-dimensional pattern observable on the visible face of the synthetic leather according to the present invention appears distinct and optically impressive, due to the magnifying function of the moisture cured polyurethane containing coating layer on top of the first layer containing platelet shaped effect pigments.

The platelet shaped effect pigments are contained in the platelet shaped effect pigments containing first layer in an amount of from 5 to 40% by weight, based on the weight of the layer. Advantageously, the content of the platelet shaped effect pigments lies in the range of from 10 to 35% by weight, preferably of from 15 to 25% by weight, based on the weight of the platelet shaped effect pigments containing first layer.

For the creation of outstanding optical effects, optically variable platelet shaped effect pigments may be present in the first layer. These pigments change their interference colour dependent on the viewing and or illumination angle. In case that those pigments are present in the platelet shaped effect pigments containing layer, the synthetic leather according to the present invention exhibits an optically variable colour in addition to the virtual three-dimensional pattern. The optically variable platelet shaped effect pigments may be present as a single kind or in combination with usually used common interference pigments.

The present invention is also directed to the use of synthetic leather as described above for any application where synthetic leathers are usually used, in particular for the production of clothes, shoes, belts, bags, playing balls, automotive parts, furniture and upholstery.

Due to its outstanding optical effects, the synthetic leather according to the present invention provides striking optical characteristics and may be produced according to the reverse coating method which is a standard procedure in the art of synthetic leather production. Therefore, the optical characteristics as well as the production cost are highly attractive to customers and producers.

The examples below are intended to explain the invention, but without limiting it. The percentages indicated are percent by weight.

### EXAMPLES

### Example 1

50 g of a polyurethane resin compound (UR-1390N, product from Shanghai Huide Chemicals) is thoroughly mixed with 40 g of DMF and 10 g of Iriodin® 305, (golden platelet shaped effect pigment based on mica, product of Merck KGaA, Darmstadt, Germany).

The resulting mixture is applied by a bar coater onto a release paper having a three-dimensional continuous rhombus pattern on its surface to give a continuous coating layer on this surface. The coated release paper is dried at 80° C. for 15 min.

100 g of the polyurethane resin (UR-1390N) are then applied onto the dry coating on the coated release paper. As long as the polyurethane resin is still in an uncured state, a fibrous synthetic leather backing layer is laminated to the wet polyurethane layer. The resulting layer stack is dried at 80° C. for another 15 min.

After the layered stack is cooled down to ambient temperature, the release paper is removed from the layered stack of polyurethane layers on the fibrous backing layer. The surface of the polyurethane layer containing the effect pigment is revealed, which exhibits a virtually two-dimensional continuous rhombus pattern of golden colour exhibiting a moderate gloss.

The effect pigment containing polyurethane layer is thereafter coated by a bar coater with a moisture curing polyurethane resin (DS-8918B, product from Shanghai Duoshen Chemicals) having an isocyanate content of about 50 to 60%, based on the weight of the resin essentially composed of isocyanate and polyurethane. The moisture curing polyurethane coating results in a continuous layer which is cured under ambient conditions for 24 hours. The resulting synthetic leather exhibits on its visible face a continuous rhombus pattern having a distinct three-dimensional effect in a profound golden colour with strong gloss. The resulting moisture cured polyurethane top layer has a dry thickness of about 500 μm.

### Example 2

Example 1 is repeated with the proviso that 10 g of Colorstream® T10-08 (platelet shaped optically variable effect pigment based on silica flakes, Product of Merck KGaA Darmstadt, Germany) is used instead of Iriodin® 305.

The resulting synthetic leather exhibits a continuous virtually three-dimensional rhombus pattern of brilliant pink colour in a steep viewing angle and golden colour in a flat viewing angle. The upper surface of the synthetic leather is smooth, plane and glossy.

### Example 3

Example 2 is repeated with the proviso that the moisture curing polymer resin composition is mixed with 2% by weight, based on the weight of the resulting coating composition, of a blue dye.

The resulting synthetic leather exhibits a continuous virtually three-dimensional rhombus pattern of brilliant lilac colour in a steep viewing angle and green colour in a flat viewing angle. The upper surface of the synthetic leather is smooth, plane and glossy.

1. Method for the production of synthetic leather having a back face and a visible face and exhibiting a virtual three-dimensional pattern on the visible face, wherein
a) a release sheet having an upper surface carrying a three-dimensional pattern thereon is coated with
b) a first layer containing platelet-shaped effect pigments and a polyurethane compound directly onto the upper surface of the release sheet, and the first layer is thereafter coated with
c) at least one further layer comprising a polyurethane compound, and
d) the further layer in a wet state is brought into contact with a substrate layer and laminated thereto, and
e) the first and the at least one further polyurethane containing layers applied to the release sheet are solidified either singly after steps b) and d) or in combination with each other after step d), whereby a layered stack of solid layers of at least the further layer, the first layer and of the release sheet on the substrate layer is achieved, and thereafter
f) the release sheet is removed from the layered stack, thereby revealing a surface of the first layer containing platelet-shaped effect pigments which exhibits a virtual two-dimensional pattern which is then coated with a coating composition comprising a moisture curing polyurethane compound and solidified in air for a time period of at least 10 hours to achieve a solid moisture cured polyurethane coating layer.

2. Method according to claim 1, characterized in that the platelet-shaped effect pigment is at least one of the group consisting of pearlescent pigments, interference pigments, metal pigments or metal effect pigments.

3. Method according to claim 1, characterized in that the platelet-shaped effect pigment is an optically variable pigment.

4. Method according to claim 1, characterized in that the platelet-shaped effect pigments exhibit a particle size in the range of from 1 to 200 μm and an aspect ratio of at least 10.

5. Method according to claim 1, characterized in that the virtual two-dimensional pattern on the surface of the first layer containing platelet-shaped effect pigments in step f) is a pattern consisting of area elements and line elements, whereby the line elements are regularly or irregularly distributed between the area elements and wherein the size of the area elements is from 0.5 mm² to 10 cm².

6. Method according to claim 1, characterized in that at least two further polyurethane containing layers are applied onto the first polyurethane containing layer comprising the platelet shaped effect pigments and that one of the further polyurethane containing layers is a middle layer composed of a polyurethane foam.

7. Method according to claim 1, characterized in that the moisture curing polyurethane compound comprises at least a polyurethane pre-polymer having free NCO— groups in the molecule.

8. Method according to claim 1, characterized in that the coating composition comprising the moisture curing polyurethane compound additionally comprises a hydroxyl group containing component having free OH— groups in the molecule.

9. Method according to claim 1, characterized in that the coating composition containing the moisture curing polyurethane compound additionally comprises at least one dye or transparent organic or inorganic colour pigment.

10. Method according to claim 1, characterized in that the coating composition containing the moisture curing polyurethane compound is solidified at a temperature in the range of from 12 to 30° C. at a relative humidity of the air in the range of from 40 to 80%.

11. Method according to claim 1, characterized in that the moisture cured polyurethane coating layer exhibits a layer thickness in the range of from 250 μm to 1000 μm.

12. Synthetic leather having a back face and a visible face and exhibiting a virtual three-dimensional pattern on the visible face, characterized in that the synthetic leather is composed of a substrate layer having thereon a stack of polyurethane containing layers, where the polyurethane containing layer which is the furthermost layer from the substrate layer comprises platelet-shaped effect pigments and is covered on its upper surface by a moisture-cured polyurethane coating layer.

13. Synthetic leather according to claim 12, characterized in that the effect pigments are contained in the platelet shaped effect pigments containing layer in an amount of from 5 to 40 % by weight, based on the weight of the layer.

14. Synthetic leather according to claim 12, characterized in that the synthetic leather exhibits an optically variable colour in addition to the virtual three-dimensional pattern.

15. Clothes, belts, shoes, bags, playing balls, automotive parts, furniture or upholstery, comprising therein synthetic leather according to claim 12.
